(19) United States
(12) Patent Application Publication
(10) Pub. No.: US 2017/0102256 A1
(43) Pub. Date: Apr. 13, 2017

(54) METHOD FOR DETERMINING THE VOLUMETRIC FLOW RATE OF A FLUID MEDIUM THROUGH A MEASURING SECTION AND ASSOCIATED MEASURING DEVICE

(71) Applicants: DIEHL METERING GMBH, ANSBACH (DE); PHYSIKALISCH-TECHNISCHE BUNDESANSTALT, BRAUNSCHWEIG (DE)

(72) Inventors: Christoph Sosna, Jinan (CN); Ulf Hammerschmidt, Braunschweig (DE)

(21) Appl. No.: 15/368,730

(22) Filed: Dec. 5, 2016

Related U.S. Application Data
(63) Continuation of application No. PCT/EP2015/001027, filed on May 20, 2015.

(30) Foreign Application Priority Data
Jun. 3, 2014 (DE) 10 2014 008 284.9

(51) Int. Cl. G01F 1/708; G01F 1/704

(52) U.S. Cl. CPC G01F 1/7084; G01F 1/7044

(57) ABSTRACT

A method for determining the volumetric flow rate of a fluid medium through a measuring section in a substantially gas-type-independent manner, includes heating the medium in a pulsed manner by using a heating element, detecting a first point in time at which a temperature maximum occurs at a first temperature sensor, the first temperature sensor being disposed adjacently upstream or downstream of the heating element, detecting a second point in time at which a temperature maximum occurs at a second temperature sensor, the second temperature sensor being disposed downstream of the heating element, the second temperature sensor being further away from the heating element than the first temperature sensor, and ascertaining a time difference between the first and second points in time. The volumetric flow rate is determined in dependence on the time difference. A device for carrying out the method is also provided.

### CROSS-REFERENCE TO RELATED APPLICATION

This is a continuation application, under 35 U.S.C. §120, of copending International Application PCT/EP2015/001027, filed May 20, 2015, which designated the United States; this application also claims the priority, under 35 U.S.C. §119, of German Patent Application DE 10 2014 008 284.9, filed Jun. 3, 2014; the prior applications are herewith incorporated by reference in their entirety.

### BACKGROUND OF THE INVENTION

### Field of the Invention

The invention relates to a method and a device for determining the volumetric flow rate of a fluid medium through a measuring section.

The determination of a volumetric flow rate of a fluid medium is important to many technical applications. In particular, depending on a measurement of such a volumetric flow rate it is possible to determine a price for a quantity of gas which is obtained. It is disadvantageous in that case that in known (in particular thermal) methods for determining a volumetric flow rate, the volumetric flow rate determination is dependent on gas parameters of the fluid medium. If the intention is to use a corresponding method for a gas type that is always the same, or a substantially constant gas composition, the gas parameters can be taken into account by a measuring section being used that is calibrated once for the corresponding medium. However, such a procedure leads to significant measurement errors in determining the volumetric flow rate if the type or the composition of the fluid medium changes.

U.S. Pat. No. 5,347,876 discloses a method in which a volumetric flow rate is ascertained by a thermal time-of-flight principle. In that case, the influence of the gas parameters of a fluid medium is compensated for by measurements of heat transport with the gas stationary. A corresponding procedure is not possible if the composition of the fluid medium can change in the course of operation.

German Patent DE 10 2012 019 657 B3 proposes taking account of the influence of gas parameters by measuring a temperature profile of the medium at two distances from a heat source at which the medium is heated in a pulsed manner, after which a thermal transport variable, in particular a thermal diffusivity, is determined from a maximum value of the temperature profile at the first distance and a maximum value of the temperature profile at the second distance. A flow velocity is subsequently ascertained depending on the thermal transport variable which is determined.

### SUMMARY OF THE INVENTION

It is accordingly an object of the invention to provide a method for determining the volumetric flow rate of a fluid medium through a measuring section and an associated measuring device, which overcome the hereinafore-mentioned disadvantages of the heretofore-known methods and devices of this general type and which enable an accurate determination of a volumetric flow rate even without a preceding determination of medium-specific gas parameters.

With the foregoing and other objects in view there is provided, in accordance with the invention, a method for determining the volumetric flow rate of a fluid medium through a measuring section in a substantially gas-type-independent manner, comprising the following steps:

heating the medium in a pulsed manner by using a heating element,

detecting a first point in time, independent of the volumetric flow rate, at which a temperature maximum occurs at a first temperature sensor, the first temperature sensor being disposed adjacently upstream or downstream with respect to the heating element,

detecting a second point in time, dependent on the volumetric flow rate, at which a temperature maximum occurs at a second temperature sensor, the second temperature sensor being disposed downstream of the heating element, wherein the second temperature sensor is further away from the heat source than the first temperature sensor,

ascertaining a time difference between the first and second points in time, and

determining the volumetric flow rate depending on the time difference.

The invention proposes determining a volumetric flow rate in a gas-type-independent manner depending on a time difference between two points in time at which a temperature maximum was ascertained at two different temperature sensors. In this case, the volumetric flow rate can be determined in particular from a flow velocity and a known geometry of the measuring section, which in particular is a measuring channel through which the medium passes with laminar flow. In this case, controlling the heating element, detecting the data of the first and second temperature sensors, ascertaining the time difference and determining the volumetric flow rate are carried out in particular by a control device associated with the measuring section. In this case, the time difference between the first and second points in time can be taken into account as the sole measurement variable in determining the volumetric flow rate. All other variables taken into account, for example the dimensions of the measuring channel and the distances between the heating element and the temperature sensors, may already be stored in the control device before the beginning of the method and be determined independently of the type of fluid medium.

The heating element can be a wire running substantially perpendicularly to the main flow direction of the medium in the measuring section. Alternatively, the heating element could also be a substantially punctiform heating element, that is to say a heating element having a very small heating area. The pulsed heating can be effected in particular by using heating times of the heating element of a few 100 μs. The control device can provide current pulses that are fed to the heating element for heating purposes.

In the method according to the invention, a first temperature sensor can be used which is at a distance of less than 100 μm, preferably between 15 μm and 50 μm, in particular between 20 μm and 30 μm, from the heating element. Through the use of a temperature sensor disposed very near or so near to the heating element, the temperature profile at that temperature sensor is substantially independent of the flow velocity of the fluid medium and thus of the volumetric flow rate and is almost exclusively dependent on the type or composition of the fluid medium, that is to say on the gas type or the composition of a gas mixture. Since the second temperature sensor is further away from the heat source, preferably at a distance of between 100 μm and 500 μm, for example 200 μm, the temperature profile at the second temperature sensor is dependent both on the flow velocity of the fluid medium and on the type or composition of the fluid medium. The invention makes use of the fact that the time difference between the first and second points in time is substantially gas-type-independent in this case. It is therefore not necessary to take into account any further parameters of the fluid medium when determining the volumetric flow rate from that time difference.

A predefined calibration curve can be used for determining the volumetric flow rate from the time difference. Alternatively, a predefined calibration curve can be used for determining the flow velocity from the time difference and known dimensions of the measuring section can be used for subsequently determining the volumetric flow rate from the flow velocity. In this case, the calibration curve may be dependent exclusively on properties of the measuring section and not on properties of the fluid medium. It is therefore possible to use the same calibration curve in a gas-type-independent manner.

A calibration curve can be implemented in particular as a table of values that is stored in the control device. In this case, it is possible that, for a time difference lying between two points of the table of values, an interpolation of the neighboring values is effected, with the nearest neighbor is chosen or the like.

It is possible to use a common calibration curve for gases having different thermal diffusivities. Supplementarily or alternatively, a gas mixture can be used as a medium, wherein a common calibration curve is used for gas mixtures having different proportions of hydrogen. It is also possible to use a common calibration curve for a plurality of different gases and/or gas mixtures. In particular, a common calibration curve can be used for all gases and gas mixtures.

In the method according to the invention, a gas parameter can be determined depending on the time interval between the point in time of heating and the detected first point in time. The gas parameter can be determined independently of further measurement values. In particular, a thermal diffusivity of the medium can be determined as the gas parameter. Supplementarily or alternatively, depending on the time interval between the point in time of heating and the detected first point in time, it is possible to distinguish between two gas types or to determine a proportion of a specific gas in a gas mixture.

In the method according to the invention, a further gas parameter can be determined depending on the temperature measurement value at the temperature maximum of the first temperature sensor and the temperature value at the temperature maximum of the second temperature sensor. In this case, the further gas parameter can be determined in particular independently of further measurement values. Alternatively, the further gas parameter can additionally be determined depending on a gas parameter determined from the time interval between the point in time of heating and the detected first point in time, or depending on the time interval itself. In particular, a thermal conductivity can be determined as the further gas parameter. If both a gas parameter and a further gas parameter are determined as explained, it is possible, in particular, to unambiguously determine a gas or a composition of a gas mixture which forms the fluid medium.

With the objects of the invention in view, there is also provided a measuring device for ascertaining a gas-type-independent volumetric flow rate of a fluid medium, comprising a measuring section with a heating element, a first temperature sensor, the first temperature sensor being disposed adjacently upstream or downstream with respect to the heating element, and a second temperature sensor, the second temperature sensor being disposed downstream of the heating element, wherein the second temperature sensor is further away from the heating element than the first temperature sensor and wherein the measuring device is constructed for carrying out the method according to the invention. The measuring device can include a control device constructed for controlling an energization of the heating element, for detecting the temperature values of the temperature sensors and for processing the measurement data.

Advantageously, the distance between the heating element and the first temperature sensor in the measuring device according to the invention is less than 100 μm, preferably between 15 μm and 50 μm, in particular between 20 μm and 30 μm. The distance between the first and second temperature sensors can be at least 100 μm, preferably between 150 μm and 550 μm, in particular between 150 μm and 350 μm. The distance between the first and second temperature sensors can also be between 200 μm and 400 μm, but even greater than 500 μm. What is achieved by a corresponding choice of the distance between the heating element and first temperature sensor and between the first and second temperature sensors is that the point in time at which a temperature maximum is detected at the first temperature sensor is substantially independent of a flow velocity or a volumetric flow rate of the medium, and the second point in time, at which a temperature maximum occurs at the second temperature sensor, has a significant dependence on the flow velocity or on the volumetric flow rate of the medium.

The first temperature sensor and the second temperature sensor can preferably be formed by wires or thin films running through the measuring channel in an exposed manner. In this case, the wires or thin films can extend in particular without an underlying substrate over a cutout in a substrate or between two substrates. Alternatively, it is possible to place wires or thin films that form the first and second temperature sensors jointly on a thin membrane, which is formed in particular from an electrically nonconductive material having a low thermal diffusivity, or to embed them into such a membrane. The described possibilities for embodying the temperature sensors prevent, in particular, heat transport through a substrate between the heating element and the first and/or the second temperature sensor from corrupting the measurement.

The thin film which is used can be, in particular, a film composed of a conductive material having a thickness of a few micrometers or a thickness of less than one micrometer. In particular, a thin film can be a few 100 nanometers thick. The wire used can preferably be a wire having a diameter of less than 10 μm. In the measuring device according to the invention, supplementarily or alternatively, the heating element can also be embodied as a wire or thin film that is disposed on a membrane or runs through the measuring channel in an exposed manner.

The heating element and/or the first and/or the second temperature sensor can be formed from metal, a metallic alloy or a semiconductor material. In this case, the semiconductor material can include silicon, in particular.

Other features which are considered as characteristic for the invention are set forth in the appended claims.

Although the invention is illustrated and described herein as embodied in a method for determining the volumetric flow rate of a fluid medium through a measuring section and an associated measuring device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of one exemplary embodiment of a measuring device according to the invention;

FIG. 2 is a perspective view of the measuring device shown in FIG. 1;

FIG. 3 is a flow diagram of one exemplary embodiment of a method according to the invention;

FIG. 4 is a diagram showing a temporal temperature profile at the heating element, the first temperature sensor and the second temperature sensor in the exemplary embodiment of the method according to the invention;

FIG. 5 is a diagram showing a relationship between a volumetric flow rate and the time interval between the point in time of heating and the detected first point in time for three different fluid media;

FIG. 6 is a diagram showing a relationship between the volumetric flow and the time interval between the point in time of heating and the second point in time for the three different fluid media; and

FIG. 7 is a diagram showing a relationship between the volumetric flow rate and the time difference between the first and second points in time for the three different fluid media.

### DETAILED DESCRIPTION OF THE INVENTION

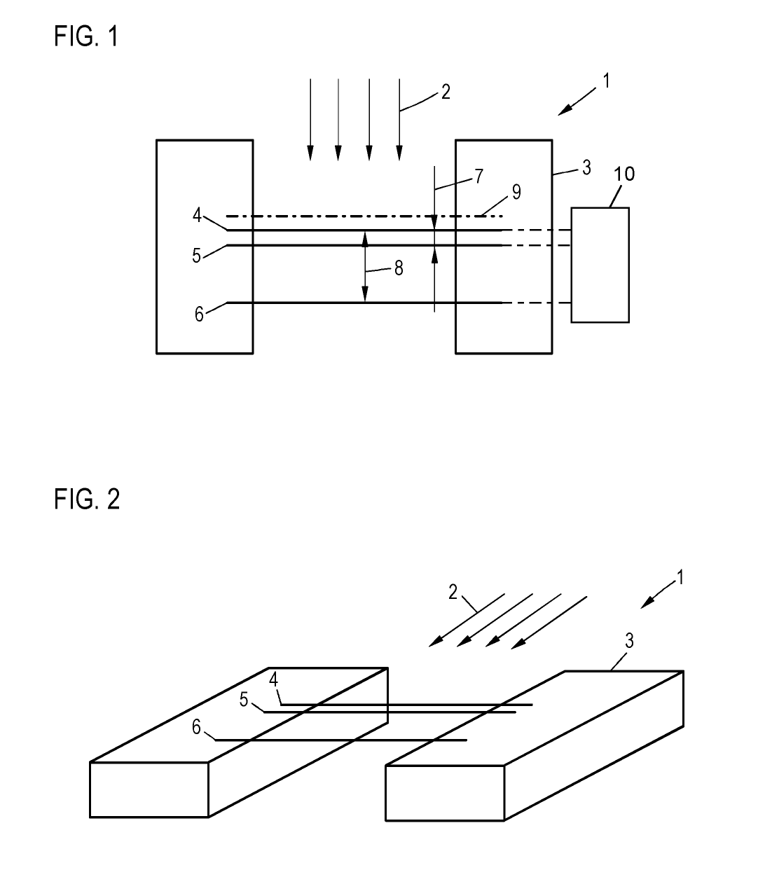

Referring now to the figures of the drawings in detail and first, particularly, to FIGS. 1 and 2 thereof, there is seen a measuring device 1 for ascertaining a gas-type-independent volumetric flow rate of a fluid medium. In this case, FIG. 1 shows a diagrammatic illustration from above and FIG. 2 shows a perspective view of the measuring device 1. A fluid medium 2, which is illustrated schematically as arrows in FIGS. 1 and 2, flows through a measuring section of the measuring device 1. In this case, the fluid medium 2 is guided in a laminar fashion in a non-illustrated measuring channel formed by a tube having a substantially rectangular cross section. In this case, the fluid medium 2 passes over a heating element 4, a first temperature sensor 5 disposed downstream of the heating element 4, and a second temperature sensor 6 spaced apart from the heating element 4 at a greater distance than the first temperature sensor 5. In this case, the heating element 4 and the temperature sensors 5, 6 are embodied as wires extending through the measuring channel between two substrates 3 in an exposed manner. In an alternative embodiment of the measuring device 1, it would also be possible for the temperature sensors 5, 6 and the heating element 4 to be embodied as thin films likewise running through the measuring channel in an exposed manner. It would likewise be possible alternatively to place the temperature sensors 5, 6 and the heating element 4 as wires or thin films on a thin membrane composed of a material having a low thermal diffusivity.

The heating element 4 and the first temperature sensor 5 are disposed at a distance of less than 50 μm from one another. That distance is indicated by a double-headed arrow 7. A distance between the second temperature sensor 6 and the heating element 4, which distance is indicated by an arrow 8, is significantly greater than the distance between the first temperature sensor 5 and the heating element, namely e.g. 450 μm.

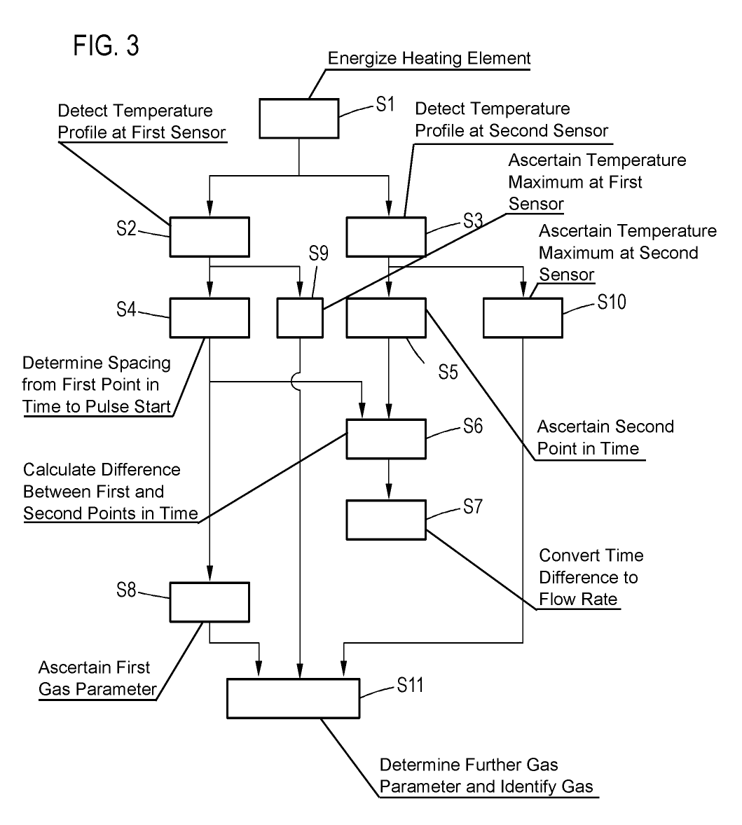

In order to measure a volumetric flow rate, a control device 10 energizes the heating element 4 with current pulses spaced apart in time, as a result of which the temperature at the heating element 4 is raised virtually in a pulsed manner for a short time period of less than 100 μs. After each heating pulse, the control device detects the temporal profiles of the temperatures at the first temperature sensor 5 and at the second temperature sensor 6. Due to the small distance between the temperature sensor 5 and the heating element 4, the temporal temperature profile at the temperature sensor 5 is virtually independent of the flow velocity or the volumetric flow rate of the fluid medium 2. Since the second temperature sensor 6 is significantly further away from the heating element 4, the temporal profile at the second temperature sensor 6 is greatly influenced by the flow velocity of the fluid medium and thus by the volumetric flow rate. As explained in even greater detail below with reference to FIG. 3, it is thus possible to determine the volumetric flow of the fluid medium in a gas-type-independent manner from the time difference between a first point in time, at which a temperature maximum occurs at the first temperature sensor 5, and a second point in time, at which a temperature maximum occurs at the second temperature sensor 6.

FIG. 1 additionally shows an alternative position for the first temperature sensor 5 as a dash-dotted line 9. Since the first temperature sensor 5 is disposed very close to the heating element 4, it is unimportant whether it is disposed upstream or downstream in terms of the gas flow.

FIG. 3 schematically shows a flow diagram of a method for determining the volumetric flow rate of a fluid medium through a measuring section in a substantially gas-type-independent manner. In a step S1, a control device 10 energizes a heating element 4 with a short current pulse of less than 100 μs, whereby the temperature at the heating element changes virtually in a pulsed manner.

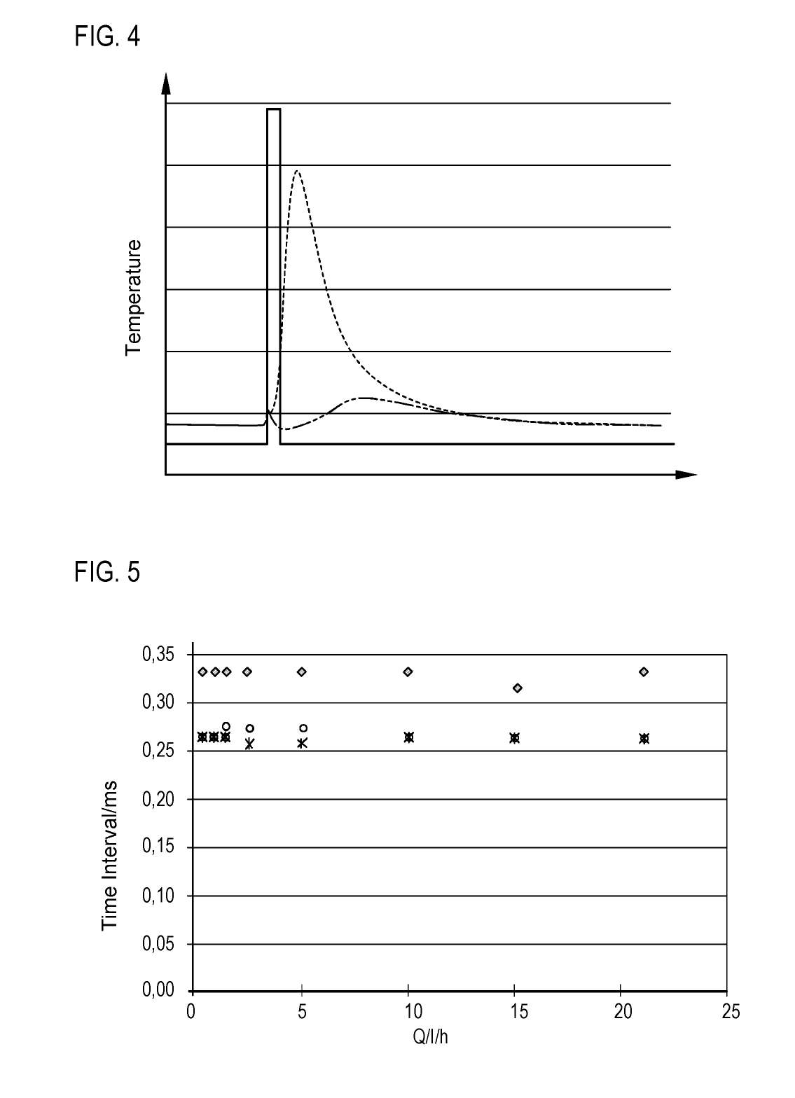

Afterward, the control device 10 simultaneously detects the temperature profile at the first temperature sensor 5 in a step S2 and the temperature profile at the second temperature sensor 6 in a step S3. The change in the temperatures at the temperature sensors 5, 6 are influenced on one hand by processes which also take place in the stationary medium, for example by diffusion, and on the other hand by the movement of the fluid medium over the heating element 4 in the direction of the second temperature sensor 6. The temperature profile at the heating element 4 and the measurement values detected by the control device 10 for the temperature sensor 5 and the temperature sensor 6 are shown schematically in FIG. 4 for a flow velocity of a fluid medium. In this case, the solid line shows the pulse-like temperature change at the heating element 4. The dashed line shows the measured temperature profile at the first temperature sensor 5 and the dash-dotted line shows the temperature profile at the second temperature sensor 6. A reduction of the maximum detected temperature and a widening of the temperature maximum can in each case be discerned therein between the temperature profile at the heating element 4, the temperature profile at the first temperature sensor 5 and the temperature profile at the second temperature sensor 6.

A temporal spacing between the first point in time at which the temperature distribution has a maximum and the beginning of the heating pulse, that is to say the start of the pulse of the solid line in FIG. 4, is determined in a step S4 from the temporal profile of the temperature at the first temperature sensor 5, that is to say for example from the dashed line from FIG. 4.

FIG. 5 shows by way of example the relationship between a volumetric flow rate and a time interval between the point in time of heating and the detected first point in time for three different gases. The measurement values for nitrogen are shown as rhombi, the measurement values for methane are shown as crosses, and the measurement values for a further natural gas are shown as circles. It can be discerned in this case that the time interval between the point in time of heating and the first detected point in time is substantially independent of the volumetric flow rate of the gas.

A step S5 involves ascertaining a second point in time, at which the temperature profile at the second temperature sensor 6, that is to say for example the dash-dotted line in FIG. 4, has a maximum.

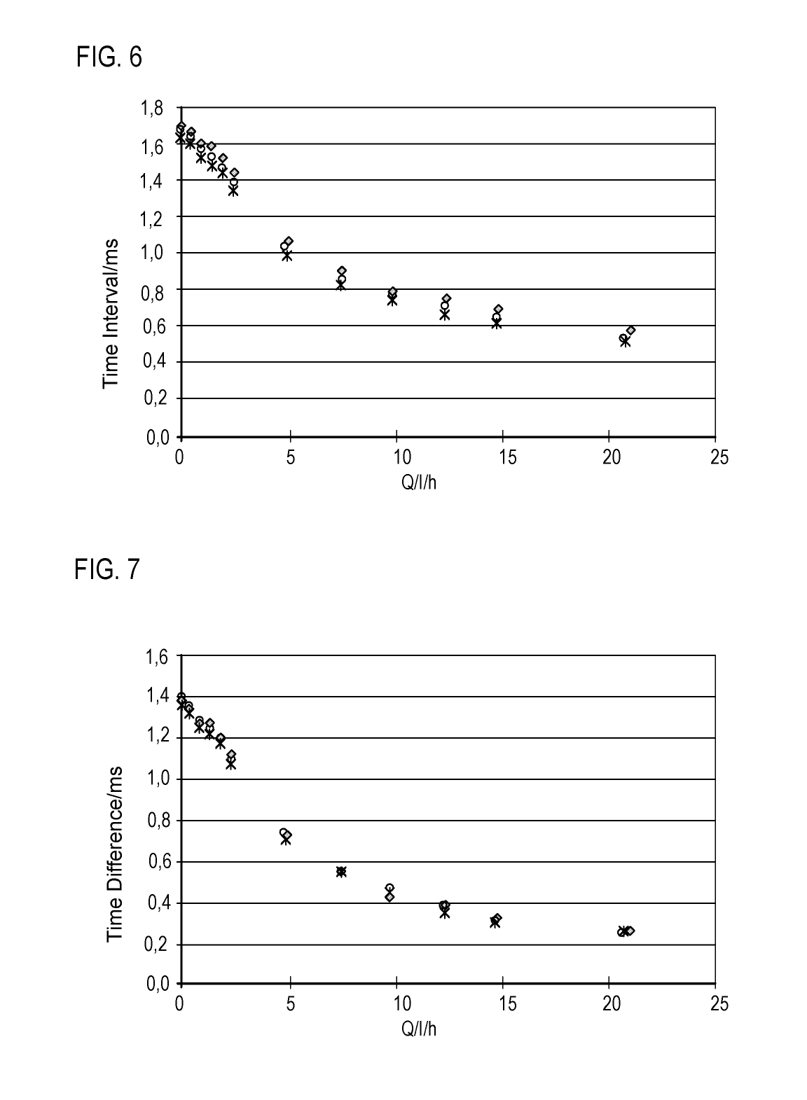

FIG. 6 shows the time intervals between the point in time of heating and the second point in time, once again for the three different gases shown in FIG. 5. It can be discerned in this case that the time difference shown in FIG. 6 is primarily dependent on the volumetric flow rate of the gases, but the time intervals, depending on the gas, have a deviation of up to approximately 20% for the same volumetric flow rate. A determination of the volumetric flow rate with a common calibration curve for the gas types shown would thus lead to relatively large measurement errors.

A step S6 involves calculating the time difference between the first and second points in time. This corresponds to subtracting the measurement values shown in FIG. 5 from the measurement values shown in FIG. 6. The result of this calculation is shown in FIG. 7 once again for the three gases and for various volumetric flow rates. The time differences for the different gases shown therein are virtually identical in the case of each volumetric flow rate. Therefore, in a step S7 it is possible to use a common calibration curve which is dependent exclusively on properties of the measuring device 1 and of the surrounding measuring channel and which is stored in the control device 10, in order to convert the time difference calculated in step S6 into a volumetric flow rate.

In order to ascertain further parameters of the fluid medium 2 besides the volumetric flow rate, in a step S8 a second calibration curve stored in the control device 10 is used to ascertain a first gas parameter, namely a thermal diffusivity, from the time interval—determined in step S4—between the point in time of heating and the first detected point in time. In this case, advantageously, thermal diffusivities for a plurality of heating intervals are calculated and averaged in order to minimize measurement errors.

In addition, the temperature value at the temperature maximum of the first temperature sensor, that is to say the maximum of the dashed curve in FIG. 4, is ascertained in a step S9 and the temperature value at the temperature maximum of the second temperature sensor 6, that is to say the maximum of the dash-dotted line in FIG. 4, is ascertained in a step S10. A step S11 involves determining a further gas parameter, namely the thermal conductivity, and additionally ascertaining what gas or what gas mixture forms the fluid medium, from these two temperature values and the gas parameter determined in step S8. In particular, multidimensional calibration curves or tables of values can be used for this purpose. In particular, it is possible, however, to determine a thermal conductivity from the temperature values calculated in step S9 and step S10 and to determine a gas type or the composition of a gas mixture from the thermal diffusivity determined in step S8 and the thermal conductivity determined. In particular, a proportion of hydrogen can be determined in this case.

1. A method for a substantially gas-type-independent determination of a volumetric flow rate of a fluid medium passing through a measuring section, the method comprising the following steps:
using a heating element to heat the medium in a pulsed manner;
providing a first temperature sensor adjacent the heating element and upstream or downstream of the heating element in a medium flow direction;
detecting a first point in time at which a temperature maximum occurs at the first temperature sensor;
providing a second temperature sensor downstream of the heating element in the medium flow direction and further away from the heating element than the first temperature sensor;
detecting a second point in time at which a temperature maximum occurs at the second temperature sensor;
ascertaining a time difference between the first and second points in time; and
determining a volumetric flow rate depending on the time difference.

2. The method according to claim 1, which further comprises placing the first temperature sensor at a distance of less than 100 μm from the heating element.

3. The method according to claim 1, which further comprises placing the first temperature sensor at a distance of between 15 μm and 50 μm from the heating element.

4. The method according to claim 1, which further comprises placing the first temperature sensor at a distance of between 20 μm and 30 μm from the heating element.

5. The method according to claim 1, which further comprises using a predefined calibration curve for determining the volumetric flow rate from the time difference.

6. The method according to claim 5, which further comprises using an identical calibration curve for gases having different thermal diffusivities.

7. The method according to claim 5, which further comprises using a gas mixture as the medium, and using an identical calibration curve for gas mixtures having different proportions of hydrogen.

8. The method according to claim 5, which further comprises using an identical calibration curve for at least one of a plurality of different gases or a plurality of gas mixtures.

9. The method according to claim 1, which further comprises determining a gas parameter in dependence on a time interval between a point in time of heating and the detected first point in time.

10. The method according to claim 9, which further comprises determining a further gas parameter in dependence on a temperature value at a temperature maximum of the first temperature sensor and a temperature value at a temperature maximum of the second temperature sensor.

11. A measuring device for ascertaining a gas-type-independent volumetric flow rate of a fluid medium, the measuring device comprising:
a measuring section having a heating element for heating the medium in a pulsed manner;
a first temperature sensor disposed adjacent said heating element and upstream or downstream of said heating element in a medium flow direction for detecting a first point in time at which a temperature maximum occurs at said first temperature sensor;
a second temperature sensor disposed downstream of said heating element in said medium flow direction for detecting a second point in time at which a temperature maximum occurs at said second temperature sensor;
said second temperature sensor being disposed further away from said heating element than said first temperature sensor; and
a control device for ascertaining a time difference between the first and second points in time and determining a volumetric flow rate depending on the time difference.

12. The measuring device according to claim 11, wherein said heating element and said first temperature sensor are spaced apart by a distance of less than 100 μm.

13. The measuring device according to claim 11, wherein said heating element and said first temperature sensor are spaced apart by a distance of between 15 μm and 50 μm.

14. The measuring device according to claim 11, wherein said heating element and said first temperature sensor are spaced apart by a distance of between 20 μm and 30 μm.

15. The measuring device according to claim 11, wherein said first and second temperature sensors are spaced apart by a distance of at least 100 μm.

16. The measuring device according to claim 11, wherein said first and second temperature sensors are spaced apart by a distance of between 150 μm and 550 μm.

17. The measuring device according to claim 11, wherein said first and second temperature sensors are spaced apart by a distance of between 150 μm and 350 μm.

18. The measuring device according to claim 11, wherein said first temperature sensor and said second temperature sensor are:
formed by wires or thin films running through said measuring channel in an exposed manner, or
disposed on a membrane situated in said measuring channel, or
embedded in a membrane situated in said measuring channel.

19. The measuring device according to claim 11, wherein at least one of said heating element or said first temperature sensor or said second temperature sensor is formed of a metal, a metallic alloy or a semiconductor material.
